(19) United States
(12) Patent Application Publication
(10) Pub. No.: US 2006/0266835 A1
(43) Pub. Date: Nov. 30, 2006

(54) Imaging module

(75) Inventor: Katsunori Tanida, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/411,908

(22) Filed: Apr. 27, 2006

(30) Foreign Application Priority Data
May 26, 2005 (JP) 2005-154337

(51) Int. Cl. G06K 7/10

(52) U.S. Cl. 235/462.01

(57) ABSTRACT

An imaging module having an imager comprised of a group of imaging elements arrayed in a square lattice and an optical system for forming two kinds of light images, a light image of a careful looking region and a light image of a surrounding region, on the imager in a lens-barrel. The optical system of the imaging module includes a plurality of lenses arranged in a cylinder direction of the lens-barrel, and one of the lenses is formed as an aspherical lens such that a sectional radius of curvature of a center part of the lens is smaller than the sectional radius of curvature of a peripheral part of the lens.

### CROSS REFERENCE TO RELATED APPLICATION

This application is based on and claims the benefit of priority of Japanese Patent Application No. 2005-154337 filed on May 26, 2005, the disclosure of which are incorporated herein by reference.

### FIELD OF THE INVENTION

This invention relates to an imaging module that is carried on board, for example, a vehicle and forms light images of a plurality of objects that should be imaged (hereinafter referred to as an imaging target) on an imager, intending to detect vehicles existing in the vicinity of the vehicle concerned or the illuminance around the vehicle, and the like.

### BACKGROUND OF THE INVENTION

Conventionally, an imaging system having an imaging module is used, for example, for imaging objects around a vehicle. The imaging system disclosed in Japanese Patent document JP-A-2004-158017 is one of the examples. The outline of the imaging module is shown in FIGS. 10 to 12 based on the description of the disclosure.

As shown in FIG. 10, this imaging system is constructed, as main constituents, with a lens-barrel 112a and a main body 112b. Among the two constituents, the lens-barrel 112a is provided with a first lens 120 with a long focal length that is suited to form a light image of a long distance scene etc. and a second lens 130 with a focal length shorter than the first lens that is suited to image objects existing at comparatively short distances, the both being integrated into a single piece. On the other hand, the main body 112b is provided with an imager 151 for forming the light image that is focused thereon through the above-mentioned lenses 120 and 130 with a group of imaging elements (illustration being omitted) that are arranged in a square lattice and are respectively having the same sensitivity, an image processor 152 for performing predetermined image processing on an original image by means of this imager 11, a memory 153 for storing and maintaining the image information thus processed and the like. Then, in this imaging system, the above-mentioned first and second lenses 120 and 130 provided on the lens-barrel 112a and the above-mentioned imager provided on the main body 112b constitute the imaging module.

FIG. 11 shows schematically an outline structure of the imaging module of the imaging system of this kind and an imaging mode of the light image of an object specified as an imaging target in the module. As shown in this FIG. 11, in this imaging module, the light image that corresponds to the upper end or the lower end of an object Ob1 coming as an imaging target by the above-mentioned first lens 120 and existing in the distance passes through the first lens 120 by proceeding an optical path L1u or an optical path L1d, respectively, and forms an image in an upper part of the imager 151. On the other hand, the light image that corresponds to the upper end or the lower end of an object Ob2 coming as an imaging target by the above-mentioned second lens 130 and existing at a shorter distance than the object Ob1 passes through the second lens 130 by proceeding an optical path L2u or an optical path L2d, respectively, and forms an image in a lower part of the imager 151. Then, a group of the imaging elements arranged on the surface of the imager 151 in a square lattice takes in the original image and the original image is subjected to compensation of contrast etc. in the image processor 152 (FIG. 10), whereby a desired image information will be acquired. Shields 140 shown in this FIG. 11 are parts that prevent the light image of the object Ob1 from entering the second lens 130 and that prevent the light image of the object Ob2 from entering the first lens 120, respectively.

FIG. 12 shows one sample of an image that is taken in by such a module carried on board, for example, a vehicle in order to detect vehicles existing in the vicinity of the vehicle concerned and the illuminance around the vehicle. As shown in FIG. 12, the image thus grabbed has images of not only the sun S1, clouds C1, buildings B1, and the like all that exist far away or in the distance but also the above-mentioned forward vehicles FC1, letters Le1 (Japanese characters in this case) painted on the road etc. all that exist at a shorter distance than the above clearly. That is, according to the imaging module, images of both imaging targets existing in the distance and imaging targets existing at a short distance can be taken in clearly without adjusting focus by the first and second lenses 120 and 130.

In an imaging module of this kind, the imager is constructed by arranging imaging elements each having the same sensitivity in a square lattice, so that the imaging elements are with the same density and can take in an image of the imaging target for the whole of its imaging range. Therefore, in order to image a region to which attention should be paid (hereinafter referred to as a careful looking region) including forward vehicles existing ahead of the vehicle with high resolution, it becomes necessary to arrange the imaging elements not only on a portion of the imager corresponding to the careful looking region but also over the whole area of the imager. Accordingly, when the imaging elements are arranged over the whole surface of the imager with high density, imaging targets in the distance that do not need high resolution will be imaged with resolution equivalent to the careful looking region, which eventually results in the increase of a processing load on the image processor 152 for performing the image processing.

When for the surrounding region surrounding the careful looking region, namely an image taking region of distant images, these are intended to be taken in for wider imaging range, it is necessary, for example, to set the angle of view θ1 of the first lens 120 wider in FIG. 11. However, since the shields 140 limit the magnitude of the angle of view θ1 in the above-mentioned conventional imaging module, it is difficult to set the angle of view θ1 larger in order to meet such a requirement. Moreover, when the shields 140 in prescribed locations is removed and thereby raising the limitation on the angle of view θ1, the light image of the object Ob2 will also enter the first lens 120, bringing reduction in the contrast of the acquired image. Further, when such reduction in the contrast is tried to be compensated by the image processor 152, increase in the processing load on the image processor 152 cannot be avoided. In this case, when there occurs reduction in the contrast of such a degree that could not be compensated by the image processor 152, it becomes impossible to acquire proper image information.

Note that the problems in above-described situation are commonly found in the imaging modules which are expected to form images of two kinds of imaging targets, distant and near, on an imager, for example, as a security camera that is installed at an entrance of a construction etc. to monitor visitors and moving objects in the surroundings and the like.

### SUMMARY OF THE INVENTION

In view of the above-mentioned situation and problems, the present invention provides an imaging module that can achieve suitable compatibility between imaging characteristics that are required for the careful looking region and for its surrounding region, respectively, while controlling a load on image processing.

The imaging module equipped with an imager in the present invention includes a group of imaging elements arranged in a square lattice and an optical system for forming two kinds of light images, an image of the careful looking region and that of its surrounding region, in it's a lens-barrel, the optical system has a plurality of lenses aligned in the cylinder direction of the lens-barrel, and one of these lenses is formed as an aspherical lens such that the sectional radius of curvature of its central part is smaller than the sectional radius of curvature of its peripheral part.

According to such a configuration of the imaging module, since one of the plurality of lenses is formed as an aspherical lens such that the sectional radius of curvature of the central part is smaller than the sectional radius of curvature of the peripheral part, the angle of view of the central part that much of the light image of the region that is defined as the above-mentioned careful looking region passes through becomes narrow, and the angle of view (imaging range) that is caught by one imaging element of the imaging elements arranged on the above-mentioned imager become comparatively narrow. To the contrary, the angle of view of the peripheral part that much of the light image of the surrounding region passes through becomes wide, and accordingly the angle of view caught by one imaging element in the array of the imaging elements arranged on the above-mentioned imager becomes comparatively wide. That is, the number of imaging elements allocated to catch the same angle of view becomes large in the central part that much of the light image of the region that is defined as the above-mentioned careful looking region passes through than that in the peripheral part that much of the light image of the above-mentioned surrounding region passes through. Therefore, the image information of the light image of the region that is defined as the careful looking region is acquired with high resolution and without distortion, whereas the image information of the light image of the surrounding region is acquired with a wide angle of view, and consequently suitable compatibility between characteristics of the light image required for the careful looking region and for the surrounding region becomes achievable. Furthermore, since this configuration does not increase the number of imaging elements that are arranged on the above-mentioned imager in a square lattice and constitute a group of imaging elements, it becomes possible to control a load on the image processing.

In another aspect of the present invention, the imaging module includes the aspherical lens formed in such a way that the sectional radius of curvature of a central part thereof is smaller than the sectional radius of curvature of other peripheral part correspondingly to an area where the light image of the region that is defined as the careful looking region in a selective manner. With this design, the imaging module is made capable of acquiring image information of the light image of the region that is defined as the careful looking region with high resolution and without distortion and acquiring image information of the light image of the surrounding region with a wide angle of view, and consequently it becomes possible to achieve compatibility between characteristics of the light image that are required for the careful looking region and for the surrounding region, respectively, more suitably.

For such aspherical lenses, the following structures are effective in terms of balancing between the process load and the precision of calculation:

(a) An area of the aspherical lens having the sectional radius of curvature of the aspherical lens smaller than the sectional radius of curvature of the peripheral part is formed in a shape of a circle when viewed from the front of the aspherical lens;

(b) An area of the aspherical lens having the sectional radius of curvature of the aspherical lens is formed smaller than the sectional radius of curvature of the peripheral part is formed in a shape of a rectangle when viewed from the front of the aspherical lens; and the like.

Incidentally, according to the imaging module as described in the paragraph (b), in the case where this imaging module is carried on board a vehicle, for example, image information of the light image in the region that is defined as the careful looking region becomes almost the same as the image information in terms of imaging region (a form) when a passenger etc. of the vehicle sees the forward of the vehicle through the front window. Therefore, in this case, it becomes possible to acquire image information that is especially effective to detect forward vehicles existing in the careful looking region.

In yet another aspect of the present invention, the imaging module includes the optical system having a plurality of lenses, that is, the aspherical lens and a convex lens for converging the light images having passed through the aspherical lens to form an image on the imager. Although with this simpler configuration, it becomes possible to easily correct aberration that is a factor of making it difficult to focus the light images of the careful looking region and its surrounding region on the imager.

In still yet another aspect of the present invention, the imaging module, when the aspherical lens and the convex lens are formed in a single piece also serving as a lens-barrel, includes fewer number of parts and is produced in fewer number of assembly steps, and consequently manufacturing costs become reducible.

In still yet another aspect of the present invention, the imaging module, when includes a light amount limiting mechanism for limiting the amount of light that has passed through the aspherical lens and is incident on the convex lens is interposed between the aspherical lens and the convex lens, and the light images of the careful looking region and of the surrounding region will reach the imager in a suitably divided manner, and each of the light images are imaged by the imager because the light images of the two regions are not mixed mutually. That is, while it becomes possible to acquire image information of an image having high contrast by the imaging module, it becomes also possible to suitably reduce a load on the image processing of performing compensation of contrast of the image information etc.

In still yet another aspect of the present invention, the imaging module includes the light amount limiting mechanism that is made up of an auto iris for automatically adjusting the amount of incident light on the convex lens according to variation in the amount of light of the light image that is an imaging target. In this manner, the contrast of the image acquired by the imaging module becomes automatically adjustable.

In still yet another aspect of the present invention, the imaging module includes the aspherical lens that is made up of a fish-eye lens. In this manner, the imaging module can be produced with a minimum number of components.

Further, the imaging module of the present invention includes an image processor for performing image processing on the light image formed on the imager that is provided in the area of the imager where the light image is not formed. In this manner, the area of the imager that is out of use is effectively utilized, and therefore it becomes possible to reduce the physical constitution of the imaging module.

Furthermore, the imaging module of the present invention has the imaging module installed as an imaging module for taking in an image ahead of the vehicle from the cabin of the vehicle through the front window, and the imaging module is configured to detect obstacles ahead of the vehicle based on the light images formed on the imager correspondingly to the careful looking region and to detect the illuminance around the vehicle based on the light image formed on the imager correspondingly to the surrounding region.

Usually, obstacles ahead of the vehicle concerned include, for example, vehicles existing in the vicinity of the vehicle, a tunnel and a bridge existing ahead of the vehicle, rain drops attached on the front window of the vehicle, and the like. When detecting these obstacles, the image information has to be taken in with sufficiently high resolution to perform predetermined image processing, such as recognition of its outer shape, without distortion. On the other hand, for detecting the illuminance around the vehicle concerned properly, image information of an image has to be taken in with a wider angle of view. Regarding this respect, according to the above-mentioned configuration as an imaging module, the obstacle ahead of the vehicle concerned are detected based on the light images formed on the imager correspondingly to the careful looking region, and the illuminance around the vehicle is detected based on the light image formed on the imager correspondingly to the above-mentioned surrounding region. As a result, characteristics of the images especially desirable as the in-vehicle imaging module become available.

Furthermore, when the imager is designed in such a way that the area located in a lower part in the gravity direction in the area where the light image is formed correspondingly to the surrounding region has a removed portion, it becomes possible to control a load on the image processing to a minimum while securing the image information of an image that is required to detect vehicles existing in the vicinity of the vehicle concerned and the illuminance around it. Moreover, in this case, arranging the image processor etc. for the removed part of the imager at a prescribed position becomes easy, and thereby enabling further miniaturization of the imaging module.

### BRIEF DESCRIPTION OF THE DRAWINGS

Other objects, features and advantages of the present invention will become more apparent from the following detailed description made with reference to the accompanying drawings, in which:

FIG. 1 shows a side view of an imaging module in a first embodiment of the present invention;

FIG. 2A shows a cross-sectional view of the imaging module in the first embodiment;

FIG. 2B shows a front view of an array of the imaging module and a light image formed thereon in the first embodiment;

FIG. 3 shows an illustration of an image acquired by the imaging module in the first embodiment;

FIG. 4A shows a cross-sectional view of the imaging module in a second embodiment;

FIG. 4B shows a front view of an array of the imaging module and a light image formed thereon in the second embodiment;

FIG. 5A shows a cross-sectional view of the imaging module in a third embodiment;

FIG. 5B shows a front view of an array of the imaging module and a light image formed thereon in the third embodiment;

FIG. 6A shows a cross-sectional view of the imaging module in the fourth embodiment;

FIG. 6B shows a front view of an array of the imaging module and a light image formed thereon in the fourth embodiment;

FIG. 7A shows a cross-sectional view of the imaging module in a fifth embodiment;

FIG. 7B shows a front view of an array of the imaging module and a light image formed thereon in the fifth embodiment;

FIG. 8A shows a cross-sectional view of the imaging module in a sixth embodiment;

FIG. 8B shows a front view of an array of the imaging module and a light image formed thereon in the sixth embodiment;

FIG. 9 shows an illustration of the imaging module in another embodiment;

FIG. 10 shows a block diagram of a conventional imaging module;

FIG. 11 shows an illustration of a target object of imaging and the light image formed by the conventional imaging module; and

FIG. 12 shows an illustration of the image acquired by the conventional imaging module.

### DETAILED DESCRIPTION OF THE PREFERRED EMBODIMENTS

### First Embodiment

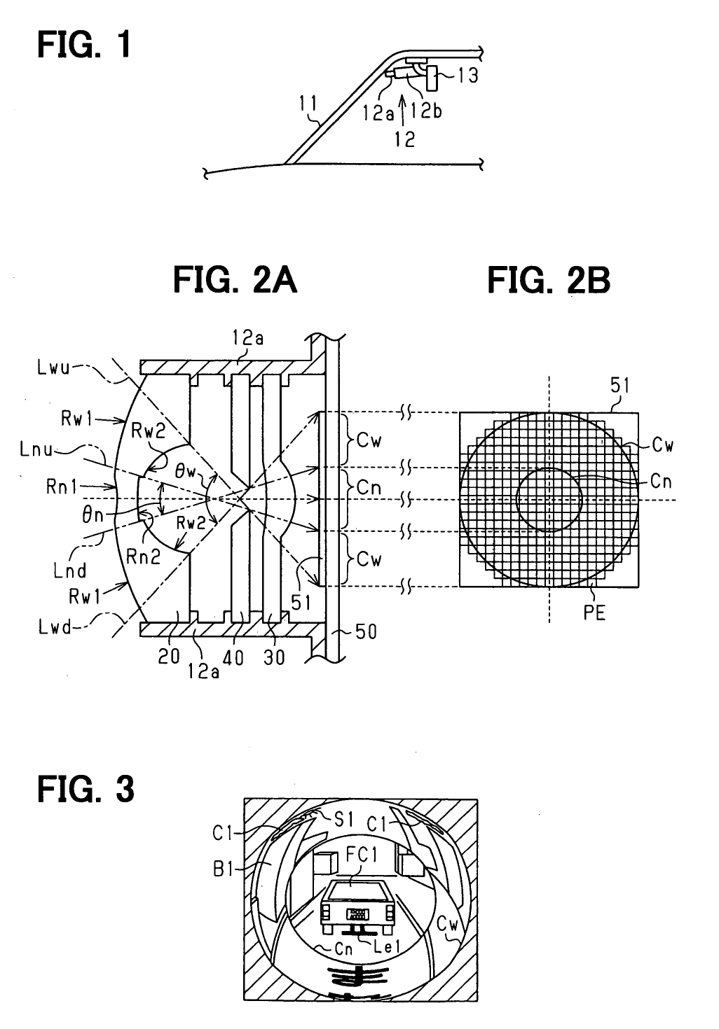

Hereafter, a first embodiment of an imaging module concerned with this invention will be described with reference to FIGS. 1 to 3.

In this embodiment, as will be described in detail below, as an optical system for forming two kinds of light images, a light image of the careful looking region and that of its surrounding region, a fish-eye lens and a convex lens for converging to form the light images having passed through the fish-eye lens on the imager are arranged inside the lens-barrel, more specifically, the two lenses are arranged along the cylinder direction. Then, this fish-eye lens is formed in such a way that the sectional radius of curvature of its central part is smaller than the sectional radius of curvature of the peripheral part, whereby suitable compatibility between imaging characteristics required for the careful looking region and for its surrounding region, respectively, is intended to be achieved.

FIG. 1 shows one example of how the imaging system equipped with the first embodiment of the imaging module concerned with this invention is provided in a prescribed location. FIG. 2A shows an internal structure of the embodiment viewed from the side direction; FIG. 2B schematically shows an arrangement mode of the imaging elements on the imager and an imaging mode of the light image viewed from the front direction. First, a configuration and functions of the imaging module will be explained referring to these FIGS. 1, 2A and 2B.

As shown in FIG. 1, an imaging system 12 equipped with the imaging module is provided on a support of a room mirror 13 in the cabin, for example, as an imaging system 12 for taking in an image ahead of the vehicle from the cabin of the vehicle through a front window 11, being constructed mainly with a lens-barrel 12a and a main body 12b.

This embodiment of the imaging module, as shown in FIG. 2A, is constructed with the following in the lens-barrel 12a, as main constituents. That is, a fish-eye lens (aspherical lens) 20 formed in such a way that the sectional radius of curvature of its central part is smaller than the sectional radius of curvature of its peripheral part and the central part takes the shape of a circle when viewed from its surface, a convex lens 30 for converging to form the light images having passed through the fish-eye lens 20 on an imager 51, an iris (light amount limiting mechanism) 40 that is interposed between the fish-eye lens 20 and the convex lens 30 and limits the amount of light that has passed through the fish-eye lens 20 and is incident on the convex lens 30, the imager 51 that is provided on a substrate 50 and on which a group of imaging elements are arranged in a square lattice, and the like.

Here, in the fish-eye lens 20, as shown in FIG. 2A, the outer surface of its central part is formed with the sectional radius of curvature Rn1 and the inner surface of the central part is formed with the sectional radius of curvature Rn2. At the same time, in the fish-eye lens 20, the outer surface of its peripheral part is formed with the sectional radius of curvature Rw1 and the inner surface of the peripheral part is formed with the sectional radius of curvature Rw2. Among these sectional radii of curvature, as is clear from FIG. 2A and as described above, a relation of “Rn2<Rw2” and a relation of “Rn1<Rw1” have been set up. That is, this fish-eye lens 20 is formed so that the sectional radius of curvature of the central part is smaller than the sectional radius of curvature of the peripheral part. Therefore, as shown in this FIG. 2A, among the light images incident on this fish-eye lens 20, light rays of an upper end and an lower end of the light image of the careful looking region mainly incident on the central part proceed light paths Lnu and Lnd, respectively, and the angle of view defined by the two light rays becomes “θn.” On the other hand, similarly as shown in FIG. 2A, among the light images incident on this fish-eye lens 20, light rays of an upper end and an lower end of the light image of the surrounding region mainly incident on the fish-eye lens 20 proceed light paths Lwu and Lwd, respectively, and the angle of view defined by the two light rays becomes “θw.” That is, the angle of view θn of the light image (light image of the careful looking region) having passed through the central part of the fish-eye lens 20 is made smaller than the angle of view θw of the light image (light image of the surrounding region) having passed through the peripheral part thereof.

Moreover, as shown in FIG. 2B, the imaging elements each having the same sensitivity are arrayed on the imager 51 with a constant density in both an area Cn where the light image having passed through the central part of the fish-eye lens 20 (light image of the careful looking region) is formed and an area Cw where the light image having passed through the peripheral part of the fish-eye lens 20 (light image of the peripheral part) is formed. Incidentally, in this imager 51, the imaging elements in specified locations in the four-corner areas the whole area subtracted by the above-mentioned area Cw, that is, areas where the light image is not formed.

In the imaging module thus configured, when detecting obstacles ahead of the vehicle concerned based on the light image formed on the imager 51 correspondingly to the above-mentioned careful looking region, as shown in FIG. 2A, light rays corresponding to the upper end of the light image of the careful looking region including vehicles existing in the vicinity of the vehicle concerned proceed the light path Lnu to reach the lower end of the area Cn of the imager 51. Moreover, light rays corresponding to the lower end of the light image of the careful looking region including vehicles existing in the vicinity of the vehicle concerned proceed the light path Lnd to reach the upper end of the area Cn of the imager 51. That is, the light image corresponding to the vehicles existing in the vicinity of the vehicle concerned forms an image on the area Cn with the angle of view θn.

On the other hand, when detecting the illuminance around the vehicle concerned based on the light image formed on the imager 51 correspondingly to the surrounding region, as shown in FIG. 2A, light rays of the surrounding region corresponding to the illuminance around the vehicle concerned proceed the light path Lwu to reach the lower end of the area Cw of the imager 51. Moreover, light rays of the surrounding region corresponding to the illuminance around the vehicle concerned proceed the light path Lwd to reach the upper end of the area Cw of the imager 51. That is, the light rays corresponding to the illuminance around the vehicle concerned form an image in the area Cw with the angle of view θw.

Then, each of the imaging elements arranged on the imager 51 outputs an electrical signal corresponding to the brightness of the light image formed as described above to the image processor (illustration being omitted), and this image processor performs image processing, such as compensation of the contrast, whereby proper image information can be acquired.

Since the light image of the careful looking region including vehicles existing in the vicinity of the vehicle concerned is formed in the area Cn of the imager 51, although the angle of view On is small, it becomes possible to take in this with high resolution and without distortion. On the other hand, since the light image of the surrounding region corresponding to the illuminance around the vehicle concerned is formed on the area Cw of the imager 51, although resolution is low, it becomes possible to take in this with a wide angle of view θw.

Next, the image acquired by this embodiment will be explained more in detail referring to FIG. 3. Here, FIG. 3 is a view showing one example of an image acquired by the imaging module in this embodiment. Note that, the image shown in FIG. 3 is formed on the imager 51 with the up and down and the right and left being inverted by the convex lens 30, but the up and down and the right and left are inverted again to show the image for the sake of convenience in FIG. 3.

As is clear from FIG. 3, a vehicle FC1 ahead of the vehicle concerned and letters Le1 (Japanese characters in the present embodiment) etc. existing in the careful looking region are grabbed in the corresponding area Cn without distortion in the whole outer shape and with high resolution. Moreover, as similarly is clear in FIG. 3, the sun S1, clouds C1, constructions B1, etc. existing in the surrounding region are taken in with a wide angle of view. That is, suitable compatibility between characteristics required to detect vehicles existing in the vicinity of the vehicle concerned and to detect the illuminance around it is realized.

As was explained in the foregoing, according to the first embodiment of the imaging module, the following excellent effects come to be acquired.

(1) An optical system for forming two kinds of light images, the light image of the careful looking region and that of its surrounding region, shall be specified to be equipped with the fish-eye lens 20 and the convex lens 30 for converging to form the light image having passed through the fish-eye lens 20 on the imager 51 in the cylinder direction of the lens-barrel 12a. The fish-eye lens 20 shall have the sectional radius of curvature of its central part smaller than the sectional radius of curvature of the peripheral part. In this manner, the angle of view en of the central part that much of the light image of the region specified as the above-mentioned careful looking region passes through becomes narrow, and accordingly the angle of view (image taking range) that is caught by one imaging element PE of the imaging elements arranged on the imager 51 also becomes comparatively narrow. Moreover, the angle of view θw of the peripheral part that much of the light image of its surrounding region passes through becomes wide, and accordingly the angle of view that is caught by one imaging element PE of the imaging elements arranged on the imager 51 also becomes comparatively wide. That is, the number of the imaging elements PE allocated for catching the same angle of view becomes greater in the central part that much of the light image of the region specified as the careful looking region than in the peripheral part that much of the light image of the surrounding region passes through. Therefore, the image information of the light image of the region specified as the careful looking region will be acquired with high resolution and without distortion, whereas the image information of the light image of its surrounding region will be acquired with a wide angle of view; therefore, suitable compatibility between characteristics of the light image required for the careful looking region and for the surrounding regions becomes achievable.

(2) Further, since the number of imaging elements PE constituting a group of imaging elements arranged in the above-mentioned imager in a square lattice is not increased, it becomes also possible to control a load on the image processing.

(3) The optical system shall be configured of the fish-eye lens 20 and the convex lens 30 for converging to form the light image having passed through the fish-eye lens 20 on the imager 51, aligned in the cylinder direction of the lens-barrel 12a. By this configuration, although being a simple configuration, it becomes possible to easily correct a factor that makes it difficult to focus the light images of the above-mentioned careful looking region and of the surrounding region on the imager 51.

(4) The imaging module shall have the iris 40 for limiting the amount of light that has passed through the fish-eye lens 20 and is incident on the convex lens 30 interposed between the fish-eye lens 20 and the convex lens 30. In this manner, the light image of the careful looking region and the light image of the surrounding region reach the imager, being separated from each other, that takes in the light images while the light images of these two regions do not mix with each other. That is, the interposed iris 40 makes it possible for the imaging module to acquire the image information of the image having high contrast.

(5) Furthermore, the image information of an image having high contrast acquired enables to suitably reduce a processor load of the image processing in terms of performing contrast compensation or the like.

(6) The imaging module shall be installed as an imaging module for taking in an image ahead of a vehicle from the cabin of the vehicle through the front window 11, and configured to detect obstacles ahead of the vehicle concerned based on the light image formed on the imager 51 correspondingly to the careful looking region and also detect the illuminance around the vehicle concerned based on the light image formed on the imager 51 correspondingly to the surrounding region. By this setting, it becomes possible for the module to realize characteristics of the light image especially preferable as the in-vehicle imaging module.

### Second Embodiment

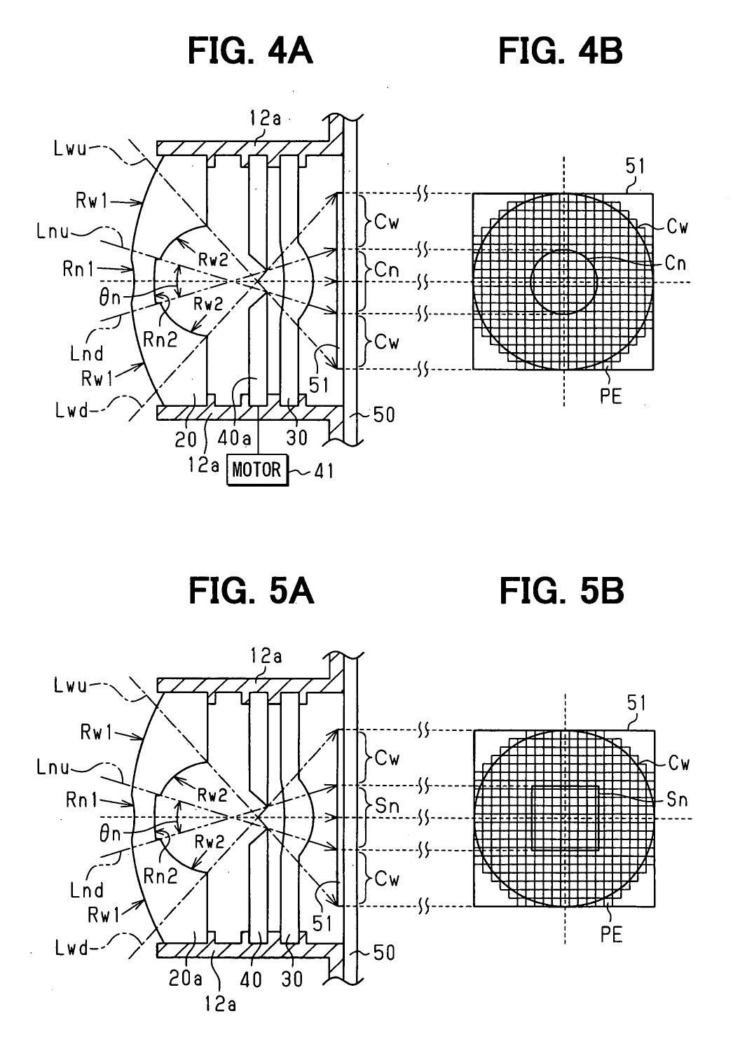

Next, a second embodiment of the imaging module concerned with this invention will be described with reference to FIGS. 4A and 4B, focusing on several points different from the first embodiment. FIG. 4A shows an internal structure of this second embodiment viewed from the side direction; FIG. 4B schematically shows an imaging mode viewed from the front direction. In FIGS. 4A and 4B, the same constituents as constituents shown in FIGS. 1 to 3 are designated with the same reference numerals, respectively, and redundant explanations of these constituents will be omitted.

As shown in FIGS. 4A and 4B, the imaging module of this embodiment has a configuration equivalent to the first embodiment shown in FIGS. 1 to 3. Note that, in this embodiment, the optical system is designed to be equipped with an auto iris 40 for automatically adjusting the amount of incident light on the convex lens, interposed between the fish-eye lens 20 and the convex lens 30, according to variation in the amount of light of the light image that is the imaging target, as a light amount limiting mechanism for limiting the amount of light that passed through the fish-eye lens 20 and is incident on the convex lens 30.

This auto iris 40 is, as shown in FIG. 4A, constructed mainly with an iris 40a and an iris motor 41, and controls the degree of opening of the iris 40a variably by properly driving the motor 41 based on a suitable drive instruction from a determination control unit (illustration being omitted).

In the imaging module thus constructed, when detecting obstacles ahead of the vehicle concerned or the illuminance around the vehicle concerned, the light images of respective regions are formed on the imager 51, respectively, as described above. In this occasion, when the contrast in the image information of an image acquired by means of the image processor (illustration being omitted), for example, the determination control unit drives the iris motor 41, so that the degree of opening of the above-mentioned iris 40a is set small. This setting makes it possible to properly maintain the contrast in the image information of an image acquired by means of the image processor.

According to the second embodiment of the imaging module described above, there are newly given effects as will be described below in addition to the effects (1)-(6) of the first embodiment.

(7) The optical system shall have the auto iris 40a interposed between the fish-eye lens 20 and the convex lens 30, the auto iris 40a serving for automatically adjusting amount of incident light on the convex lens 30 according to variation in the amount or light of the light image that is an imaging target as a light amount limiting mechanism for limiting the amount of light that passed through the fish-eye lens 20 and is incident on the convex lens 30. This configuration allows the degree of opening of the iris 40a to be automatically set variable, and consequently it becomes possible to automatically adjust the contrast in the image information of an image acquired by means of the imaging module.

### Third Embodiment

Next, a third embodiment of the imaging module concerned with this invention will be described with reference to FIGS. 5A and 5B, focusing on several points different from the first embodiment. FIG. 5A shows an internal structure of this third embodiment viewed from the side direction; FIG. 5B schematically shows an imaging mode on the imager viewed from the front direction.

As shown in FIGS. 5A and 5B, the imaging module of this embodiment has a configuration equivalent to the first embodiment shown in FIGS. 1 to 3. Note that, in this embodiment, as shown in FIGS. 5A and 5B, the area where the sectional radius of curvature of the fish-eye lens 20a is formed smaller than the sectional radius of curvature of the peripheral part other than the area concerned is formed in the shape of a rectangle when viewed from the front.

According to this third embodiment of the imaging module explained above, effects as will be described below can newly be acquired, in addition to the effects (1)-(6) of the first embodiment.

(8) The area of the fish-eye lens 20a where the sectional radius of curvature thereof is formed smaller than the section radius of curvature of the peripheral part other than the area concerned shall be formed in the shape of a rectangle when viewed from the front of the fish-eye lens 20a. By this specification, for example, in the case where this imaging module is carried on board of a vehicle, the image information of the light image of the region that was defined as the careful looking region becomes an imaging region (shape) Sn that is almost similar to the image information when a passenger etc. of the vehicle concerned sees the forward of the vehicle through the front window. Therefore, in this case, it becomes possible to acquire image information especially effective to detect forward vehicles existing in the careful looking region.

### Fourth Embodiment

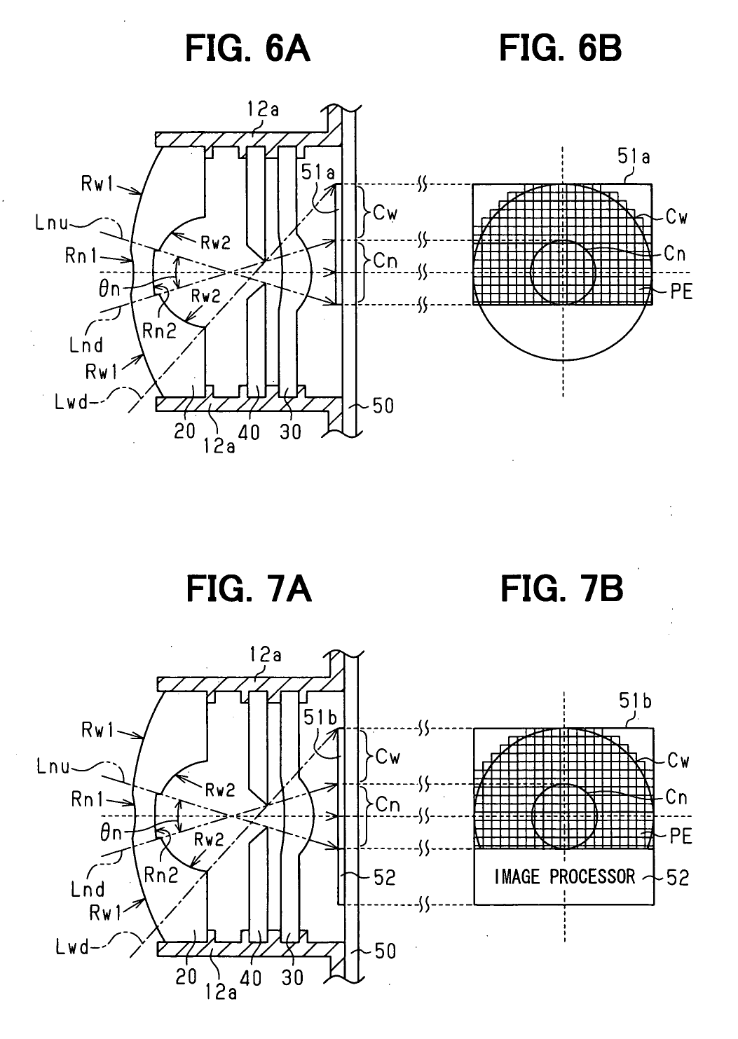

Next, a fourth embodiment of the imaging module concerned with this invention will be described with reference to FIGS. 6A and 6B, focusing on several points different from the first embodiment. FIG. 6A shows an internal structure of the fourth embodiment viewed from the side direction; FIG. 6B schematically shows an imaging mode on the imager viewed from the front direction.

As shown in FIGS. 6A and 6B, the imaging module of this embodiment has a configuration equivalent to the first embodiment shown in FIGS. 1 to 3. Note that, in this embodiment, as shown in FIGS. 6A and 6B, an imager 51a is formed in the shape such that a part of the area located in a lower part in the gravity direction in the area where the light image is formed correspondingly to the surrounding region is removed.

According to the fourth embodiment of the imaging module described above, the following effects come to be acquired newly, in addition to the above-mentioned effects (1)-(6) of the first embodiment.

(9) The imager 51a shall be made with a shape such that a part of the area located in the lower portion in the gravity direction in the area where the light image is formed correspondingly to the surrounding region is removed. By this configuration, while securing image information of the image required to detect vehicles existing in the vicinity of the vehicle concerned and the illuminance around it, it becomes possible to reduce a load on the image processing.

### Fifth Embodiment

Next, a fifth embodiment of the imaging module concerned with this invention will be described with reference to FIGS. 7A and 7B, focusing on several points different from the first embodiment. FIG. 7A shows an internal structure of the fifth embodiment viewed from the side direction; FIG. 7B schematically shows an imaging mode on the imager viewed from the front direction.

As shown in these FIGS. 7A and 7B, the imaging module of this embodiment has a configuration equivalent to the first embodiment shown in FIGS. 1 to 3. Note that in this embodiment, as shown in FIGS. 7A and 7B, an image processor 52 for performing image processing on the light image formed on an imager 51b in the area of the imager 51b where the light image is not formed.

According to this fifth embodiment of the imaging module described above, effects described below will be acquirable newly in addition to the above-mentioned effects (1)-(6) of the first embodiment.

(10) The imager 51b shall be provided with the image processor 52 for performing image processing on the light image formed on the imager 51b in an area where the light image is not formed. With this design, the area of the imager 51b that is not in use is effectively utilized, which makes it possible to reduce the volume of the imaging module.

### Sixth Embodiment

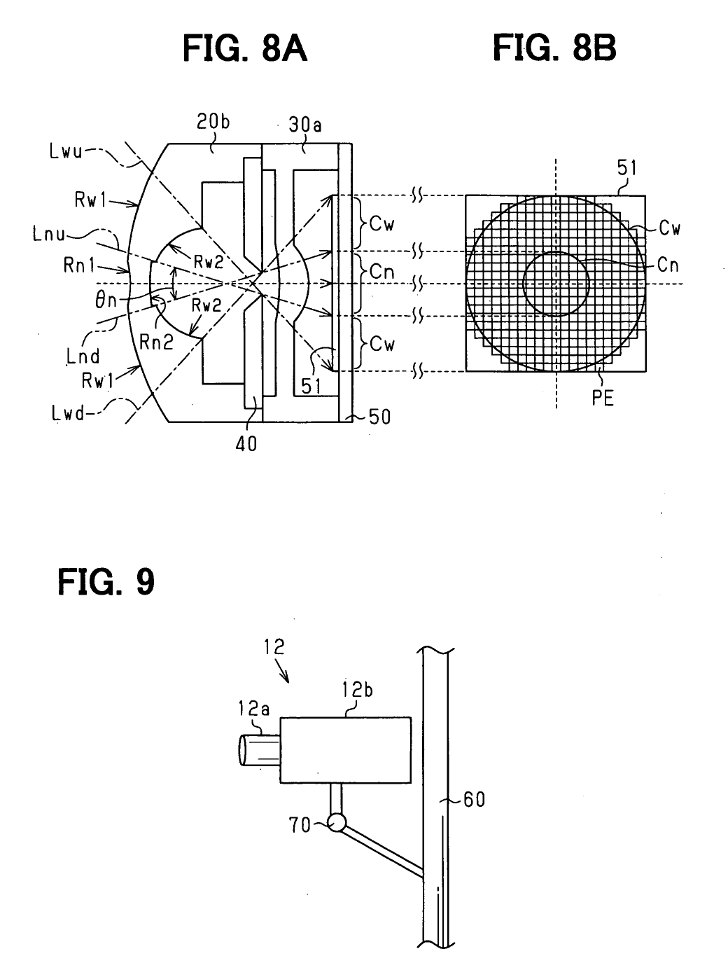

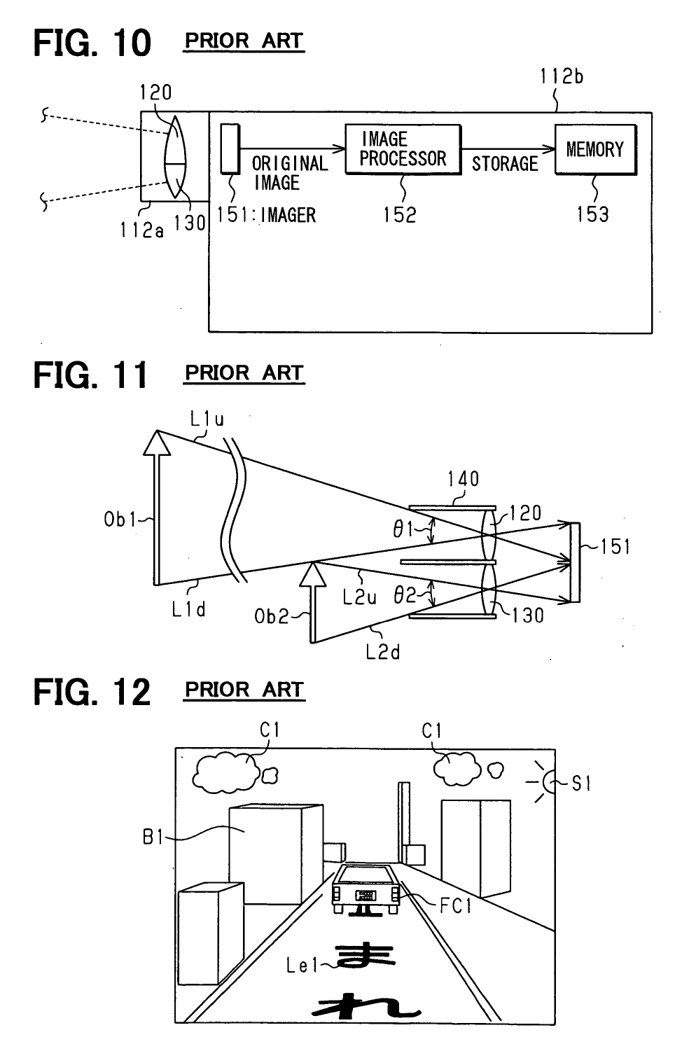

Next, a sixth embodiment of the imaging module concerned with this invention will be described with reference to FIGS. 8A and 8B, focusing on several points different from the first embodiment. FIG. 8A shows an internal structure of this sixth embodiment viewed from the side direction; FIG. 8B schematically shows an imaging mode on the imager viewed from the front direction.

As shown in FIGS. 8A and 8B, the imaging module of this embodiment has a configuration equivalent to the first embodiment shown in FIGS. 1 to 3. Note that, in this embodiment, as shown in FIGS. 8A and 8B, the fish-eye lens 20b and the convex lens 30a are formed as a single piece respectively with the lens-barrel.

According to this sixth embodiment of the imaging module explained above, a following effect can be acquired newly in addition to the above-mentioned effects (1)-(6) of the first embodiment.

(11) The fish-eye lens 20b and the convex lens 30a shall be formed as a single piece respectively with the lens-barrel. This structure achieves reduction in the number of parts and steps of assembly, and consequently it becomes possible to reduce manufacturing costs.

### Other Embodiment

Note that the imaging module concerned with this invention is not restricted to the configurations exemplified by the embodiments but the invention may be carried on as a modification that is altered from the embodiments appropriately, for example, as embodiments described below.

Although the embodiments described above adopts a structure in which the imaging elements are arranged in the areas Cn (Sn) and Cw where the light images are formed on the imager 51 (imagers 51a-51b) and no imaging element PE is arranged in areas of four corners of the light receiving area from which these areas are excluded, a style of arrangement of the imaging elements is not limited to this form. In such an area on which the light image is not formed or an area where the light image is formed but image information of the image is not needed, the following points and the like can be adopted arbitrarily:

(a) Arrangement of the imaging elements that correspond to these areas is dispensed with (the fourth embodiment).

(b) The image processor 52 that performs image processing on the light images formed on the imager 51 is provided (the fifth embodiment).

(c) Not restricted to the image processor 52, for example, a circuit that performs a suitable control by determining information on the contrast acquired through analysis processing, information on vehicle kind, etc. is incorporated in the image processor.

That is, an expected effect in the examples (a), (b) and (c) is that imaging elements PE for capturing the light image are arranged in the area where the light image is formed.

In each of the embodiments, the iris 40 or auto iris 40a is adopted as a light amount limiting mechanism, which is interposed between the fish-eye lens 20 and the convex lens 30, whereby the amount of light that has passed through the fish-eye lens- and is incident on the convex lens 30 is limited. However, the light amount limiting mechanism is not limited to this form. That is, as long as the light amount limiting mechanism can separate the light image of the careful looking region and the light image of its surrounding region, and can maintain or improve the contrast, its configuration may be arbitrarily determined.

In each of the embodiments described above, the area where the sectional radius of curvature of the fish-eye lens 20 or 20a is specified to be made smaller than the sectional radius of curvature of the peripheral part other than the area concerned is designed to be in the form of a circle or rectangle when viewed from the front surface of the fish-eye lens 20 or 20a. However, a shape of the area when viewed from the front is not limited to this form. That is, the imager can acquire image information of an image in which obstacles existing ahead of the vehicle are taken in with high precision and without distortion in the careful looking region and, in terms of illuminance, with as wide an angle of view as possible. The shape of the area viewed from the front may be arbitrarily determined. For example, the shape of the area may be in a form of a barrel, i.e., a circle with an upper and lower portion of arc removed therefrom, or in a form of an oval. In each of the embodiments described above, as one example of the aspherical lens, the fish-eye lens 20 shall be adopted to partially constitute the imaging module. However, the aspherical lens is not limited to this form. That is, any wide-angle lens with a sufficiently wide angle of view may be used.

In each of the above-mentioned embodiments, the plurality of lenses constituting the optical system shall consist of the aspherical lens and the convex lens 30 that focuses to form the light images having passed through the aspherical lens on the imager. However, the plurality of lenses are not limited to this composition. For the plurality of lenses constituting the optical system, more lenses may be adopted to constitute the optical system.

In each of the embodiments, the imaging module is installed as an imaging module for taking in an image of vehicles ahead of the vehicle concerned from the cabin of the vehicle through the front window and is assigned to detect obstacles ahead of the vehicle concerned or the illuminance around the vehicle concerned based on image information of an image acquired from the imaging module. However, use of the imaging module is not limited to this kind. Regarding the use of the imaging module, for example, as shown in FIG. 9 serving as a figure corresponding to FIG. 1, the imaging module may be installed on a wall 60 of an entrance/exist or the like of a construction or may be used as a security camera to monitor visitors and moving objects in the surroundings based on image information of an image acquired from this imaging module. That is, as long as the imaging module is used as an imaging module for forming an image of two kinds of imaging targets, distant and near, on the imager 51, its scope of use may be arbitrarily determined. Moreover, when capturing the light image of a moving object in the area Cw on the imager 51, in order to take in the moving object with higher resolution, that is, capturing the light image of the moving object in the area Cn, the imaging system 12 itself may be directed to the moving object by means of a driving unit 70. This capability can enhance the function thereof as a security camera further.

What is clamed is:

1. An imaging module having an imager comprised of a group of imaging elements arrayed in a square lattice and an optical system for forming two kinds of light images, a light image of a careful looking region and a light image of a surrounding region, on the imager in a lens-barrel, wherein
the optical system includes a plurality of lenses arranged in a cylinder direction of the lens-barrel, and
one of the lenses is formed as an aspherical lens such that a sectional radius of curvature of a center part of the lens is smaller than the sectional radius of curvature of a peripheral part of the lens.

2. The imaging module according to claim 1, wherein
the aspherical lens has an area of the center part,
the area of the center part corresponds to the light image of a region that is specified as the careful looking region in a selective manner, and
the sectional radius of curvature of the area of the center part is smaller than the sectional radius of curvature of the peripheral part.

3. The imaging module according to claim 2, wherein
the area of the aspherical lens having the sectional radius of curvature made smaller than the sectional radius of curvature of the peripheral part is formed in a shape of a circle when the area is viewed from a front of the aspherical lens.

4. The imaging module according to claim 2, wherein
the area of the aspherical lens having the sectional radius of curvature made smaller than the sectional radius of curvature of the peripheral part is formed in a shape of a rectangle when the area is viewed from the front of the aspherical lens.

5. The imaging module according to claim 2, wherein
the area of the aspherical lens having the sectional radius of curvature made smaller than the sectional radius of curvature of the peripheral part is formed in a shape of a barrel when the area is viewed from the front of the aspherical lens.

6. The imaging module according to claim 2, wherein
the area of the aspherical lens having the sectional radius of curvature made smaller than the sectional radius of curvature of the peripheral part is formed in a shape of an oval when the area is viewed from the front of the aspherical lens.

7. The imaging module according to claim 1, wherein
the plurality of lenses constituting the optical system comprise the aspherical lens and a convex lens, and
the convex lens converges the light images having passed through the aspherical lens to form the light image on the imager.

8. The imaging module according to claim 7, wherein
the aspherical lens and the convex lens are formed as portions of the lens-barrel.

9. The imaging module according to claim 7, wherein
a light amount controlling mechanism for controlling an amount of incident light having passed through the aspherical lens toward the convex lens is interposed between the aspherical lens and the convex lens.

10. The imaging module according to claim 9, wherein
the light amount limiting mechanism is an auto iris for automatically adjusting the amount of the incident light toward the convex lens according to variation in the amount of the incident light of the light image from an imaging target.

11. The imaging module according to claim 1, wherein
the aspherical lens is a fish-eye lens.

12. The imaging module according to claim 1, wherein
an area of the imager in which the light image is not formed is provided with an image processor for performing image processing on the light image formed on the imager.

13. The imaging module for taking in an image of a front of a vehicle concerned from a cabin of the vehicle through a front window according to claim 1, wherein
the image of the front of the vehicle concerned is used to detect obstacles ahead of the vehicle based on the light image that is formed on the imager correspondingly to the careful looking region, and
the image of the front of the vehicle is used to detect the illuminance around the vehicle based on the light image that is formed on the imager correspondingly to the surrounding region.

14. The imaging module according to claim 13, wherein
a part of the imager in a gravitationally lower direction for imaging the light image corresponding to the surrounding region is removed.
